(19) United States
(12) Patent Application Publication
(10) Pub. No.: US 2001/0048094 A1
(43) Pub. Date: Dec. 6, 2001

(54) Flame extinguishment composition and method of making and using same

(76) Inventors: Arnulf P. Hagen, Norman, OK (US); Sherril D. Christian, Norman, OK (US); Edwin E. Tucker, Norman, OK (US); Cedomir M. Sliepcevich, Washington, OK (US); Jerry L. Lott, Norman, OK (US)

Correspondence Address: Dunlap, Codding & Rogers, P.C., Suite 420, 9400 North Broadway, Oklahoma City, OK, 73114, US

(21) Appl. No.: 09/801,971

(22) Filed: Mar. 8, 2001

Related U.S. Application Data
(63) Continuation of application No. 08/851,046, filed on May 5, 1997, now abandoned.

(51) Int. Cl. A62D 1/00; A62C 2/00

(52) U.S. Cl. 252/3; 252/4

(57) ABSTRACT

A fire extinguishment composition is provided which demonstrates excellent synergistic effects of component materials. The fire extinguishment composition includes an effective amount of a first flame extinguishment agent and an effective amount of a second flame extinguishment agent. The first flame extinguishment agent may be any chemical substance which is capable of extinguishing a flame by decreasing the amount of oxygen concentration in an atmosphere required to support combustion, by decreasing the flame temperature, or combinations of the two mechanisms. The second flame extinguishing agent is any chemical substance which is capable of releasing an effective amount of chemical fragments so as to interfere with a chemical chain mechanism responsible for propagation of the flame.

### BACKGROUND OF THE INVENTION

1. Field of the Invention

The present invention relates generally to a fire extinguishment composition and a method for making and using same, and more particularly to a fire extinguishment composition having a physical agent and a chemical agent, wherein the physical agent and the chemical agent cooperatively interact so as to provide a more effective and cost efficient system for fire extinguishment.

2. Brief Description of the Background Art

Fire extinguishment compositions have been known in the art for many years. It is also well known that fire suppressant agents may operate by either a physical or chemical mechanism. For example, nitrogen and CO₂, when added to a flame, act primarily by the physical mechanism of reducing oxygen concentrations in the air, whereas many chemical agents function by depleting the concentration of chain-propagating radical species.

Carbon dioxide has long been used as an effective fire extinguishment agent. It suppresses flames primarily through a dilution effect (reduction of oxygen partial pressure in the fuel-air mixture) and an enthalpic effect reflecting the increase in heat capacity caused by the presence of CO₂ in the gas mixture near the flame. Carbon dioxide is useful in fire suppression when its local volume percent in air (equivalent to mole percent) in the vicinity of the fire exceeds approximately 20%. On the other hand, much smaller quantities of the chemical agents such as halons (e.g. Halon 1301, CF₃Br, and Halon 1211, CF₂BrCl) are required in suppressing fires, 3 or 4 volume percent, for example.

The existence of synergistic effects (e.g. the use of less individual components when mixed together than the amount each alone would be required to achieve the same effect) in fire suppression mixtures is important because such a composition would provide an economical, safer, and more effective fire suppression composition. Furthermore, the use of a chemical agent which is substantially halogen free would be less toxic to people and the environment than Halons 1301 and 1211, which have traditionally been used in chemical fire suppression compositions.

The relevant literature in the art provides little or no quantitative evidence that the combination of physical and chemical agents show synergistic or cooperative effects in suppressing fires. Although it has been reported that mixtures of CF₃Br and CF₂BrCl, two chemical agents, are somewhat more effective in fire extinguishment than would be expected if they acted independently, our test results indicate no synergistic effect occurring for mixtures of two or more physical agents nor would there be any synergistic effect from the combination of two or more chemical agents. In an article by Ronald S. Sheinson, entitled “Halon Alternatives Extinguishment Pathways”, presented at the Halon Alternatives Technical Working Conference in Albuquerque, N. Mex., on Apr. 30-May 1, 1991, it was disclosed that a mixture of a physical agent and a chemical agent may exhibit nonlinear effects due to the different fire suppression mechanisms of each substance. Sheinson's results, however, indicate that a negligible synergistic effect occurred, thereby prompting the conclusion that the combination of a physical and chemical agent would result in nothing more than a non linear additive effect.

Tests conducted on mixtures of chemical agents and physical agents demonstrate that, contrary to the above referenced Sheinson article, the fire extinguishing capability of these systems is highly synergistic. In fact, a simple model has been developed to predict fire composition synergism ability, and more particularly to develop extinguishment compositions containing both physical and chemical agents. Synergism between chemical and physical agents allow the reduction of the amount of physical and chemical compounds required in flame extinguishment compositions. By using mixtures of chemical agents and physical agents, a reduction factor in concentration of the chemical agent on the order of three or four fold may be achieved. Consequently, in order to achieve fire extinguishment capabilities as large as that currently used, the new synergistic compositions require only 25-35% as much chemical agent. Ultimately, this confers both economic and environmental benefits. Moreover, the use of mixtures of chemical agents and physical agents allow for a two-fold or more reduction in the amount of physical agent required, thereby diminishing the danger of physical agent poisoning. For example, by using a physical agent such as nitrogen, by itself, approximately 33% by volume of nitrogen must be added to the air in order to put out a fire. However, since in actual practice it is specified to use 1.1 to 1.4 times this amount (36-46%), the use of even nitrogen alone as a physical flame-extinguishing agent might in some applications be dangerous. On the other hand, if fire extinguishers were to contain mixtures of nitrogen and a chemical agent showing synergistic effects, significantly less nitrogen would be required.

Thus it is an object of the present invention to provide a fire extinguishment composition comprising a physical agent and a chemical agent, which synergistically interrelate so as to provide an extinguishment composition which is highly effective, economically favorable, and environmentally safe.

It is a further object of this invention to provide a method for extinguishing a fire by using a fire extinguishment composition comprising an effective amount of a physical agent and an effective amount of a chemical agent.

It is also an object of the present invention to provide a fire suppression composition having a mixture of a physical agent and a non-halon containing chemical agent which is capable of producing free radicals.

These and other objects of the present invention will become apparent in light of the present specification, claims, and drawings.

### SUMMARY OF THE INVENTION

The present invention provides a fire extinguishment composition comprised of an effective amount of a first flame extinguishing agent and an effective amount of a second flame extinguishing agent. The fire extinguishment composition is formulated by combining the first and second flame extinguishing agents together in a ratio characterized by the formula (A/Aₒ)+(B/Bₒ)<0.80, and more particularly less than 0.75, wherein Aₒ is defined as an amount of the first flame extinguishing agent effective in extinguishing the flame when used alone, and Bₒ is defined as an amount of the second flame extinguishing agent effective in extinguishing the flame when used alone. Where used herein, the terms “fire extinguishment agent” and “flame extinguishment agent”, are intended to be used interchangeably.

The first flame extinguishing agent is any chemical substance capable of extinguishing a flame by (1) decreasing the amount of oxygen concentration in an atmosphere required to support combustion, (2) by decreasing the flame temperature, or (3) combinations of the two. The second flame extinguishing agent is any chemical substance capable of releasing an effective amount of chemical fragments which will be capable of interfering with the chemical chain mechanism responsible for propagation of a flame.

The first flame extinguishing agent is contemplated as being nitrogen, helium, argon, and mixtures thereof, as well as carbon dioxide or a fluorohydrocarbon, such as FM-200. The first flame extinguishing agent may be a combination of the above described chemicals. In any event, one of ordinary skill in the art will appreciate that any chemical substance capable of (1) decreasing the amount of oxygen concentration in an atmosphere required to support combustion, (2) decreasing the flame temperature, or (3) combinations of the two, is contemplated as being within the scope of the invention.

The second flame extinguishing agent is contemplated as being a halogenated hydrocarbon compound, such as an iodinated, brominated, chlorinated, or fluorinated hydrocarbons, and combinations thereof. For instance, the halogenated hydrocarbon compound may be diiodomethane (CH₂I₂). It is also contemplated that the second flame extinguishing agent be an iodinated, brominated, chlorinated, or fluorinated alkane such as pentafluoroethyliodide, perfluorohexyliodide, and perfluorooctylbromide, and combinations thereof.

The second flame extinguishing agent may also be Halon 1301 or Halon 1211. Furthermore, the second flame extinguishing agent may be selected from the group consisting of metal carbonyls, metal compounds containing both carbonyl and CF₃ groups, or combinations of metal carbonyls and compounds containing both carbonyl and CF₃ groups. For instance, the second flame extinguishing agent may be iron pentacarbonyl or chromium hexacarbonyl. It is further contemplated that the second flame extinguishing agent be a compound containing iodine, where the iodine is capable of releasing iodine chemicals which will interfere with the chemical chain mechanism responsible for flame propagation, such as HI, I₂, and IBr. The second flame extinguishing agent may also be an inorganic substance which contains bromine, where the inorganic substance is capable of releasing bromine chemicals which will interfere with the chemical chain mechanism responsible for flame propagation, such as HBr. In any event, one of ordinary skill in the art will appreciate that any chemical substance capable of releasing an effective amount of chemical fragments which will be capable of interfering with the chemical chain mechanism responsible for propagation of a flame, is contemplated as being within the scope of the invention.

For example, in one embodiment of the invention, it is contemplated that the first flame extinguishing agent is carbon dioxide and the second flame extinguishing agent is CH₂I₂. In yet another embodiment of the invention, it is contemplated that the first flame extinguishing agent is FM-200 and the second flame extinguishing agent is CH₂I₂.

In an alternate embodiment of the invention, a fire extinguishment composition is provided as including an effective amount A of a first flame extinguishing agent and an effective amount B of a second, substantially halogen-free, flame-extinguishing agent. The fire extinguishment composition in this embodiment is characterized by the formula (A/Aₒ)+(B/Bₒ)<1.00, where Aₒ is defined as an amount of the first flame extinguishing agent which is effective in extinguishing the flame when used alone, and Bₒ is defined as an amount of the second substantially halogen-free flame extinguishing agent which is effective in extinguishing the flame when used alone.

In yet another alternate embodiment of the present invention, a fire extinguishment composition is provided as including an effective amount A of a first flame extinguishing agent and an effective amount B of a second flame extinguishing agent. The fire extinguishment composition in this embodiment is characterized by the formula (Aₒ−A)/B>8, and more particularly greater than 10, where Aₒ is defined as an amount of the first flame extinguishing agent effective in extinguishing the flame when used alone. The first flame extinguishing agent is a chemical substance which is capable of extinguishing a flame by decreasing the amount of oxygen concentration in an atmosphere required to support combustion, by decreasing the flame temperature, or by combinations thereof. The second flame extinguishing agent is a chemical substance capable of releasing an effective amount of chemical fragments so as to interfere with a chemical chain mechanism responsible for propagation of a flame.

The present invention also provides a fire extinguishment composition prepared by a process which includes the steps of: (1) providing an effective amount A of a first fire extinguishing agent; (2) providing an effective amount B of a second fire extinguishing agent; and (3) combining the effective amount A of the first fire extinguishing agent with the effective amount B of the second fire extinguishing agent into an effective mixture. The fire extinguishing mixture, as prepared, is characterized by the formula (A/Aₒ)+(B/Bₒ)<0.80, and more particularly less than 0.75, where Aₒ is defined as an amount of the first fire extinguishing agent which is effective in extinguishing a fire when used alone, and Bₒ is defined as an amount of the second fire extinguishing agent which is effective in extinguishing a fire when used alone.

The present invention further provides a method for extinguishing a fire. The method comprises the steps of (1) providing an effective amount of a fire extinguishment composition; and (2) applying the effective amount of the fire extinguishment composition to a fire for extinguishing the fire. The fire extinguishment composition includes an effective amount A of a first flame extinguishing agent, and an effective amount B of a second flame extinguishing agent. The first and second flame extinguishing agents are combined to form a mixture, wherein the mixture is characterized by the formula (A/Aₒ)+(B/Bₒ)<0.80, and more particularly less than 0.75, where Aₒ is defined as an amount of the first fire extinguishing agent which is effective in extinguishing a fire when used alone, and Bₒ is defined as an amount of the second fire extinguishing agent which is also effective in extinguishing a fire when used alone.

In an alternate embodiment of the method of the present invention, the method includes the steps of (1) providing a fire extinguishment composition and (2) applying an effective amount of the fire extinguishment composition to a fire for extinguishing the fire. The fire extinguishment composition comprises a mixture of an effective amount A of a first flame extinguishing agent and an effective amount B of a substantially halogen-free flame extinguishing agent. The mixture is characterized by the formula (A/Aₒ)+(B/Bₒ)<1.00, where Aₒ is defined as an amount of the first flame extinguishing agent which is effective in extinguishing the flame when used alone, and Bₒ is defined as an amount of the second substantially halogen-free flame extinguishing agent which is effective in extinguishing the flame when used alone.

In another embodiment of the method of the present invention, a method for extinguishing a fire is provided which includes the steps of (1) providing a fire extinguishment composition and (2) applying an effective amount of the fire extinguishment composition to a fire for extinguishing the fire. It is contemplated that the fire extinguishment composition comprise an effective amount A of a first flame extinguishing agent and an effective amount B of a second flame extinguishing agent. The composition is characterized by the formula (Aₒ−A)/B>8, and more particularly greater than 10, where Aₒ is defined as an amount of the first flame extinguishing agent which is effective in extinguishing the flame when used alone.

The first flame extinguishing agent of this embodiment may be a chemical substance capable of extinguishing a flame by decreasing the amount of oxygen concentration in an atmosphere required to support combustion, by decreasing the flame temperature, or by combinations thereof. Furthermore, the second flame extinguishing agent may be a chemical substance capable of releasing an effective amount of chemical fragments so as to interfere with a chemical chain mechanism responsible for propagation of the flame.

The present invention also provides an apparatus for use in extinguishing a fire. The apparatus includes a housing having an interior surface, an exterior surface, and means for venting a fire extinguishment composition, and a fire extinguishment composition substantially deposited in the housing. The fire extinguishment composition comprises (1) an effective amount A of a first flame extinguishing agent, and (2) an effective amount B of a second flame extinguishing agent. The first and second flame extinguishing agents are combined to form a mixture characterized by the formula (A/Aₒ)+(B/Bₒ)<0.80, and more particularly less than 0.75, where Aₒ is defined as an amount of the first flame extinguishing agent which is effective in extinguishing the flame when used alone, and Bₒ is defined as an amount of the second flame extinguishing agent which is effective in extinguishing the flame when used alone.

The present invention further provides a fire extinguishment kit. The fire extinguishment kit includes an effective amount A of a first fire extinguishing agent and an effective amount B of a second fire extinguishing means. The fire extinguishment kit also includes a means for combining the first and second flame extinguishing agents in order to thereby provide a fire extinguishment mixture for application to a fire. The fire extinguishment mixture is characterized by the formula (A/Aₒ)+(B/Bₒ)<0.80, and more particularly less than 0.75, where Aₒ is defined as an amount of the first flame extinguishing agent which is effective in extinguishing a fire when used alone, and Bₒ is defined as an amount of the second flame extinguishing agent which is effective in extinguishing a fire when used alone.

### BRIEF DESCRIPTION OF THE SEVERAL VIEWS OF THE DRAWINGS

FIG. 1 is a graph detailing the cup burner experiment with results for a flame extinguishment composition comprising CO₂ and CF₃Br.

FIG. 2 is a graph detailing the cup burner experiment with results for a flame extinguishment composition comprising CO₂ and CF₂BrCl.

FIG. 3 is a graph detailing the cup burner experiment with results for a flame extinguishment composition comprising N₂ and CF₃Br.

FIG. 4 is a graph detailing the cup burner experiment with results for a flame extinguishment composition comprising N₂ and CF₂BrCl.

FIG. 5 is a graph detailing the synergistic or cooperative effects of composition as plotted as extinguishment factor F.

FIG. 6 is a perspective view of a fire extinguisher constructed in accordance with the present invention.

FIG. 7 is a perspective view of a homogeneous solution of non-halogenated chemical agent and CO₂ in a cylindrical fire extinguisher container.

FIG. 8 is a graph detailing the cup burner experimental results for a flame extinguishment composition comprising CO₂ and N₂.

FIG. 9 is a graph detailing the cup burner experimental results for a flame extinguishment composition comprising CF₃Br and CO₂.

FIG. 10 is a graph detailing the cup burner experimental results for a flame extinguishment composition comprising C₂F₅I and CO₂.

FIG. 11 is a graph detailing the cup burner experimental results for a flame extinguishment composition comprising Halon 1211 and CO₂ extinguishment factor F as a function of the relative percentage variable.

FIG. 12 is a schematic diagram of a total flooding testing device in accordance with the present invention.

FIG. 13 is a graph detailing the total flooding results with varying percentages of CO₂ initially added to air in a combustion flask.

FIG. 14 is a graph detailing the total flooding results with varying percentages of C₇F₁₄ initially added to air in a combustion flask.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present invention provides a fire extinguishment composition comprised of an effective amount of a first flame extinguishing agent and an effective amount of a second flame extinguishing agent. The fire extinguishment composition is formulated by combining the first and second flame extinguishing agents together in a ratio characterized by the formula (A/Aₒ)+(B/Bₒ)<0.80, and more particularly less than 0.75, wherein Aₒ is defined as an amount of the first flame extinguishing agent effective in extinguishing the flame when used alone, and Bₒ is defined as an amount of the second flame extinguishing agent effective in extinguishing the flame when used alone.

The first flame extinguishing agent is any chemical substance capable of extinguishing a flame by (1) decreasing the amount of oxygen concentration in an atmosphere required to support combustion, (2) by decreasing the flame temperature, or (3) combinations of the two. The second flame extinguishing agent is any chemical substance capable of releasing an effective amount of chemical fragments which will be capable of interfering with the chemical chain mechanism responsible for propagation of a flame. The combination of the physical and chemical agent results in a fire extinguishment composition which uses less of each component that would typically be required for flame extinguishment by either component individually.

The first flame extinguishing agent is contemplated as being nitrogen, helium, argon, and mixtures thereof, as well as carbon dioxide or a fluorohydrocarbon, such as FM-200. The first flame extinguishing agent may be a combination of the above described chemicals as well. In any event, one of ordinary skill in the art will appreciate that any chemical substance capable of (1) decreasing the amount of oxygen concentration in an atmosphere required to support combustion, (2) decreasing the flame temperature, or (3) combinations of the two, is contemplated as being within the scope of the invention for use as the first flame extinguishing agent.

The second flame extinguishing agent is contemplated as being a halogen-containing fluorohydrocarbon compound, such as an iodinated, brominated, or chlorinated fluoroalkane, and combinations thereof. For instance, the halogen-containing fluorocarbon compound may be diiodomethane. It is also contemplated that the second flame extinguishing agent be selected from the group consisting of iodinated, brominated, or chlorinated alkanes such as pentafluoroethyliodide, perfluorohexyliodide, and perfluorooctylbromide, and combinations of iodinated, brominated and chlorinated alkanes.

The second flame extinguishing may also be Halon 1301 or Halon 1211. Furthermore, the second flame extinguishing agent may be selected from the group consisting of metal carbonyls, metal compounds containing both carbonyl and CF₃ groups, or combinations of metal carbonyls and compounds containing both carbonyl and CF₃ groups. For instance, the second flame extinguishing agent may be iron pentacarbonyl or chromium hexacarbonyl. It is further contemplated that the second flame extinguishing agent be a compound containing iodine, where the iodine is capable of releasing iodine-containing fragments which will interfere with the chemical chain mechanism responsible for flame propagation, such as HI, I₂, and IBr. The second flame extinguishing agent may also be an inorganic substance which contains bromine, where the inorganic substance is capable of releasing bromine-containing fragments which will interfere with the chemical chain mechanism responsible for flame propagation, such as HBr. In any event, one of ordinary skill in the art will appreciate that any chemical substance capable of releasing an effective amount of chemical fragments which will be capable of interfering with the chemical chain mechanism responsible for propagation of a flame, is contemplated as being within the scope of the invention.

For example, in one embodiment of the invention, it is contemplated that the first flame extinguishing agent is carbon dioxide and the second flame extinguishing agent is CH₂I₂. In yet another embodiment of the invention, it is contemplated that the first flame extinguishing agent is FM-200 and the second flame extinguishing agent is CH₂I₂. Once again, it should be appreciated by one of ordinary skill in the art that any flame extinguishment composition comprising first and second flame extinguishment agents, and having the properties herein described, is contemplated for use.

### EXAMPLE I

In order to test the effectiveness of the fire extinguishment composition, a cup-burner apparatus, as is well known in the art, was constructed and utilized to test the claimed fire extinguishment composition. Heptane was used as the fuel, and various physical agents, such as carbon dioxide, and various chemical agents, such as CF₃Br or CF₂BrCl, were combined to form a fire extinguishment composition. Rotameters were used to establish the flow rates of the air, nitrogen, and carbon dioxide while the chemical agents were calibrated against wet test meters. An air volume of 35 L per minute was allowed to flow through the glass chimney of the cup burner apparatus. The minimum vapor phase concentration of the fire extinguishment composition which was required to extinguish the flame was determined by gradually increasing the agent concentration in the cup burner apparatus until the flame abruptly vanished.

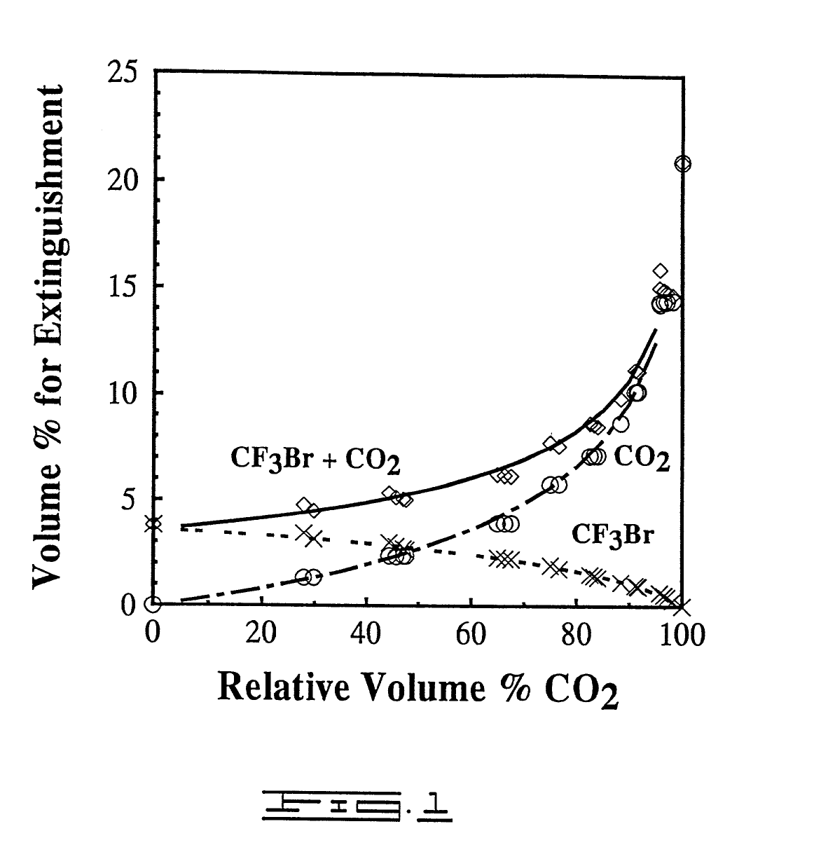

Results from the cup burner experiment for a fire extinguishment composition comprising carbon dioxide and CF₃Br are plotted in FIG. 1, and tabulated in Table 1.

TABLE 1
CO₂ + CF₃Br FIG. 1

| CO₂ | CF₃Br % | total | Rel. % CO₂ |
|---|---|---|---|
| 21 | 0 | 21 | 100 |
| 14.3 | 0.63 | 15.93 | 95.8 |
| 14.4 | 0.64 | 15.04 | 95.73 |
| 14.42 | 0.52 | 14.94 | 96.49 |
| 14.42 | 0.52 | 14.94 | 96.57 |
| 14.43 | 0.43 | 14.86 | 97.11 |
| 14.45 | 0.26 | 14.71 | 98.21 |
| 10.2 | 0.995 | 11.19 | 91.1 |
| 10.2 | 0.946 | 11.15 | 91.5 |
| 10.21 | 0.921 | 11.13 | 91.72 |
| 8.71 | 1.14 | 9.85 | 88.46 |
| 8.71 | 1.14 | 9.85 | 88.46 |
| 7.17 | 1.36 | 8.53 | 84.08 |
| 7.17 | 1.43 | 8.6 | 83.33 |
| 7.16 | 1.51 | 8.67 | 82.6 |
| 5.82 | 1.77 | 7.59 | 76.66 |
| 5.81 | 1.94 | 7.75 | 75 |
| 5.81 | 1.94 | 7.75 | 75 |
| 3.94 | 2.22 | 6.18 | 67.57 |
| 3.94 | 2.26 | 6.2 | 66.37 |
| 3.94 | 2.31 | 6.25 | 64.94 |
| 2.39 | 2.63 | 5.03 | 47.62 |
| 2.35 | 2.8 | 5.15 | 45.69 |
| 2.39 | 2.99 | 5.38 | 44.33 |
| 2.39 | 2.69 | 5.08 | 47.12 |
| 1.34 | 3.16 | 4.49 | 29.8 |
| 1.34 | 3.13 | 4.47 | 29.9 |
| 1.33 | 3.44 | 4.78 | 27.93 |
| 0 | 3.8 | 3.8 | 0 |

The upper curve represents the total percent of the combined CO₂ and CF₃Br required for flame extinguishment, which plotted against the relative percentage of CO₂ in the gas stream that is mixed with the air before it enters the cup burner apparatus. FIG. 1 also shows the separate or partial volume percentages of CO₂ and CF₃Br in an atmosphere which are required for flame extinguishment, both of which are also plotted against the relative percentage of CO₂ in the gas stream that is mixed with the air before it enters the cup burner apparatus.

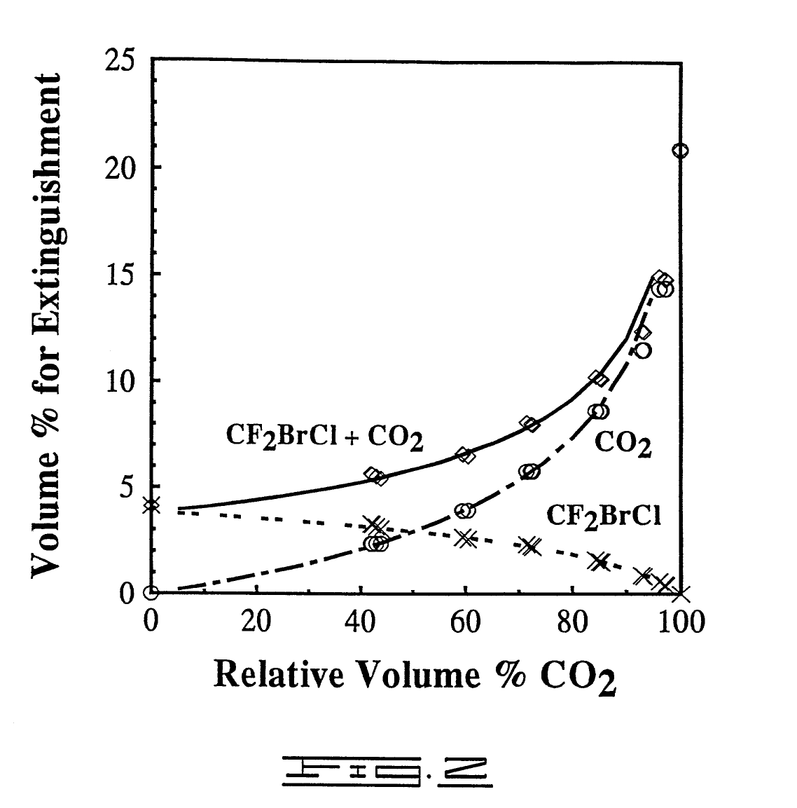

Results from a second cup burner experiment testing a fire extinguishment composition comprising CO₂ and CF₂BrCl are plotted in FIG. 2 and tabulated in Table 2. As in FIG. 1, the upper curve represents the total percent of the combined CO₂ and CF₂BrCl required for flame extinguishment, and the separate or partial volume percentages of CO₂ and CF₂BrCl in an atmosphere which are required for extinguishment. All of the data is plotted against the relative percentage of CO₂ in the gas stream that is mixed with the air before it enters the cup burner apparatus.

The relative CO₂ percentage variable, plotted as the abscissa in FIGS. 1 and 2, is calculated in the following manner. If, for example, the air stream flowing through the cup burner chimney contains 6.0 mole percent CO₂ and 2.0 mole percent CF₃Br (along with 92.0 mole percent air), the relative percent CO₂ is calculated to be 6.0/(6.0+2.0)×100=75%. Comparing this number to FIG. 1 shows in fact that this relative percent CO₂ will indeed extinguish the flame, because it contains a total mole percent of the two agents of 8.0%, somewhat greater than the indicated percentage shown on the upper curve for a relative percent of CO₂ equal to 75.

The apparent nonlinearity of the data, as expressed by the curves in FIGS. 1 and 2, indicates that a significant cooperative or synergistic effect exists in mixtures of a physical fire-suppressant agent (CO₂) and individual chemical agents (CF₃Br and CF₂BrCl). FIG. 1 shows that while 21 volume percent of CO₂ in air is required to extinguish the flame when CO₂ is used alone, a 90/10 volume percent mixture of CO₂ and CF₃Br, respectively, will extinguish the flame at a total volume percentage of the agent mixture of approximately 11%. The individual volume percentages of agent and CO₂ in the air stream, resulting from the use of this mixture, are 1.1 and 9.9, respectively. In other words, the quantity of CO₂ required to extinguish the flame is reduced to less than half (9.9% vs. 21%) by the addition of only 1.1% of CF₃Br. Simultaneously, the quantity of CF₃Br is reduced to less than one third (1.1% vs. 3.8%) by the addition of 9.9% CO₂.

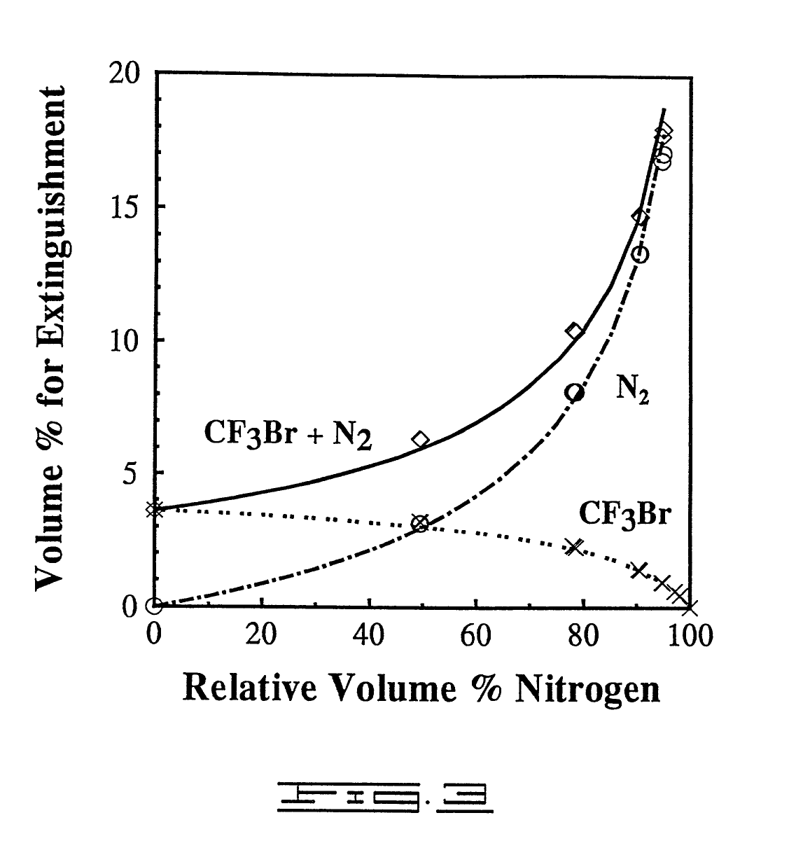

FIG. 3 plots the results of a cup burner test for a fire extinguishment composition comprising N₂ and CF₃Br. The plot shows that small amounts of the chemical agent CF₃Br in a fire extinguishment composition will contribute to quite a large reduction in the concentration of nitrogen which is required to extinguish a flame. The 90/10 volume percent mixture of nitrogen and CF₃Br requires volume percentages of these substances in the air of about 13% for nitrogen (vs. 33% for N₂ alone) and 1.4% for CF₃Br (vs. 3.8% for CF₃Br alone).

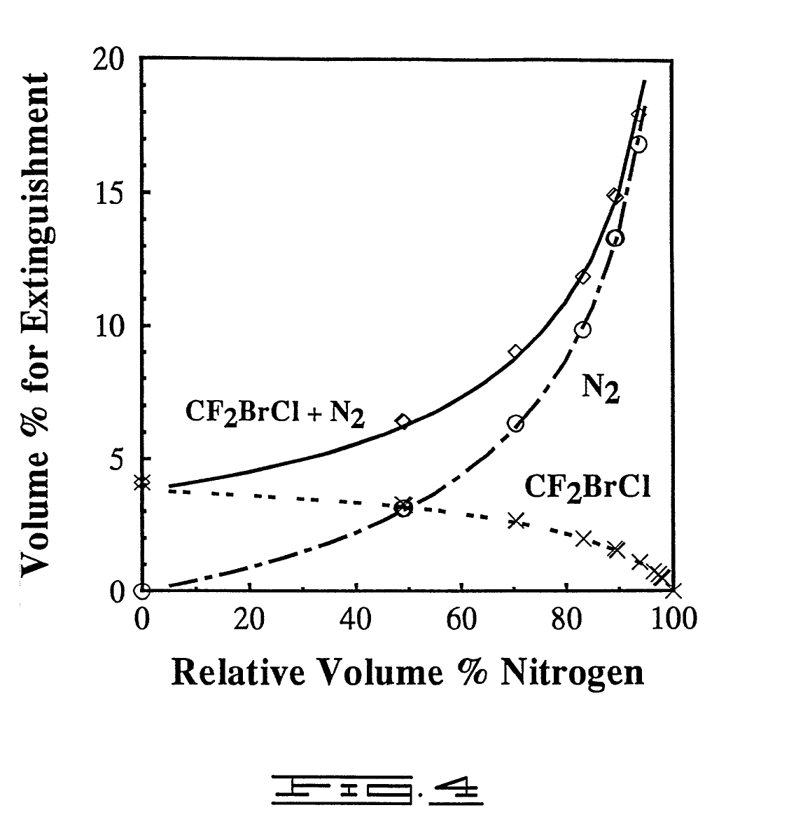

FIG. 4 plots the results of a cup burner test for a fire extinguishment composition comprising N₂ and CF₂BrCl. The plot of FIG. 4 shows analogous cooperative flame-extinguishment effects seen in FIGS. 1-3. It should be mentioned that the two chemical agents CF₃Br and CF₂BrCl are similar in their ability to suppress fires in the presence of either CO₂ or N₂ as the physical agent. Of the two chemical agents, it appears that CF₂BrCl is somewhat less effective, and that a slightly larger percentage of CF₂BrCl is required at all relative percentages of either CO₂ or N₂, as compared to the CF₃Br.

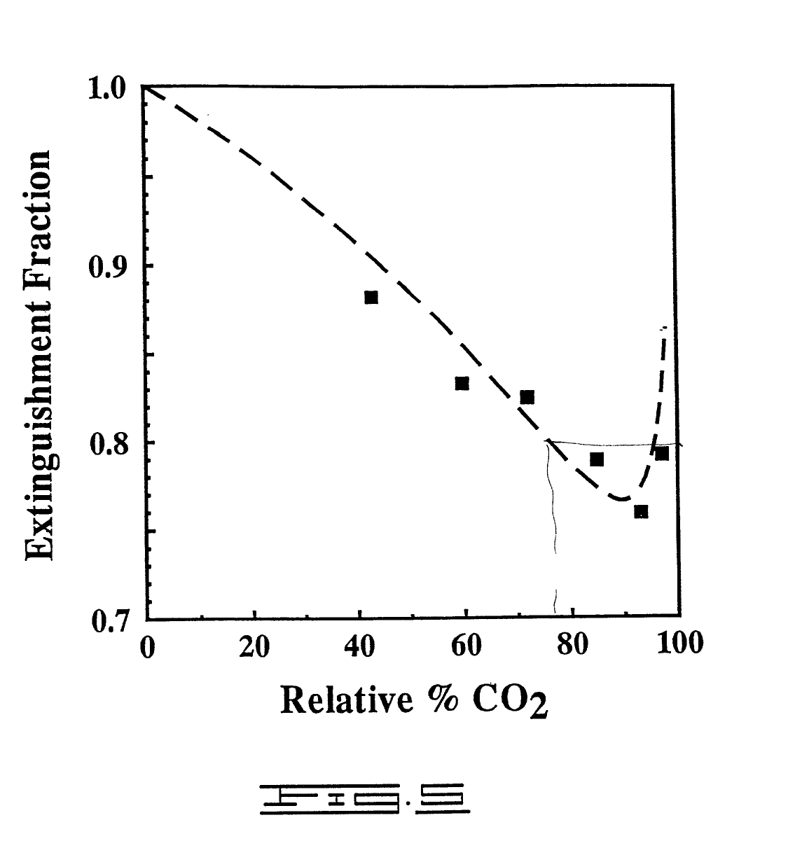

The large synergistic or cooperative effects observed in FIGS. 1-4, is clearly shown in FIG. 5 which is a plot of the extinguishment factor F, against the relative percentages of the physical agent and chemical agent in the mixture which is added to the atmosphere in order to extinguish the flame. The extinguishment factor F is defined by the expression (A/Aₒ+B/Bₒ), where Bₒ is the minimum percentage of the chemical agent required to extinguish the fire in the absence of the physical agent and B is the percentage of the chemical agent required to extinguish the flame when combined with the physical agent; similarly, Aₒ is the percentage of the physical agent required to extinguish the flame in the absence of the chemical agent and A is the percent of the physical agent required to extinguish the flame when combined with the chemical agent. The value of the extinguishment factor would equal one if there was no synergistic effect occurring in the flame extinguishment composition.

FIG. 5 plots the results of a cup burner test for a fire extinguishment composition comprising CO₂ and CF₂BrCl with the extinguishment factor F plotted against the relative percent of CO₂ in the CO₂/CF₂BrCl mixture used. The minimum of the curve occurs at a mixture having approximately a 10:1 volume ratio of CO₂ to CF₂BrCl, indicating that mixtures rich in CO₂ have an enhanced synergistic effect.

Initially, the synergistic effect shown in FIGS. 1-5, including the large 90% CO₂ decrease, may appear to imply that the physical agents may be able to interact specifically with the chemical agent or that the physical agent decomposes, thereby enhancing flame extinguishment. However, the mechanism by which the physical agents extinguish a fire must be addressed as well. The major purpose of using a physical agent in flame suppression is to diminish the percentage of oxygen in the air stream as well as to increase the heat capacity of the mixture heated by combustion. These two effects cause the flame temperature to decrease. It has been found that at concentrations of either 21% CO₂ or 33% N₂, which are the percentages of these gases necessary to extinguish the heptane flame in cup-burner tests, flame temperature will be lowered by approximately the same amount. In turn, if the volume percentages of the diluent gases in the atmosphere air stream are reduced to half, the amount of physical agent required for fire-extinguishment will be approximately half. However, by lowering the flame temperature, the rate of production of free radicals participating is greatly diminished thereby decreasing the amount of chemical agent required to put out a flame. Thus, chemical agents, such as any of the halons, will extinguish a flame at lower chemical agent concentrations when combined with a physical agent.

It has also been found that mixtures of physical agents (e.g., CO₂ and N₂ or CO₂ and perfluoromethylcychlohexane) do not exhibit synergistic effects. The absence of a synergistic effect would have a suppression factor equal to 1. It is also contemplated that fluorohydrocarbon chemical agents, which are believed to suppress fires primarily through physical effects, would show little, if any, synergistic effects when mixed with other physical agents such as CO₂ or N₂.

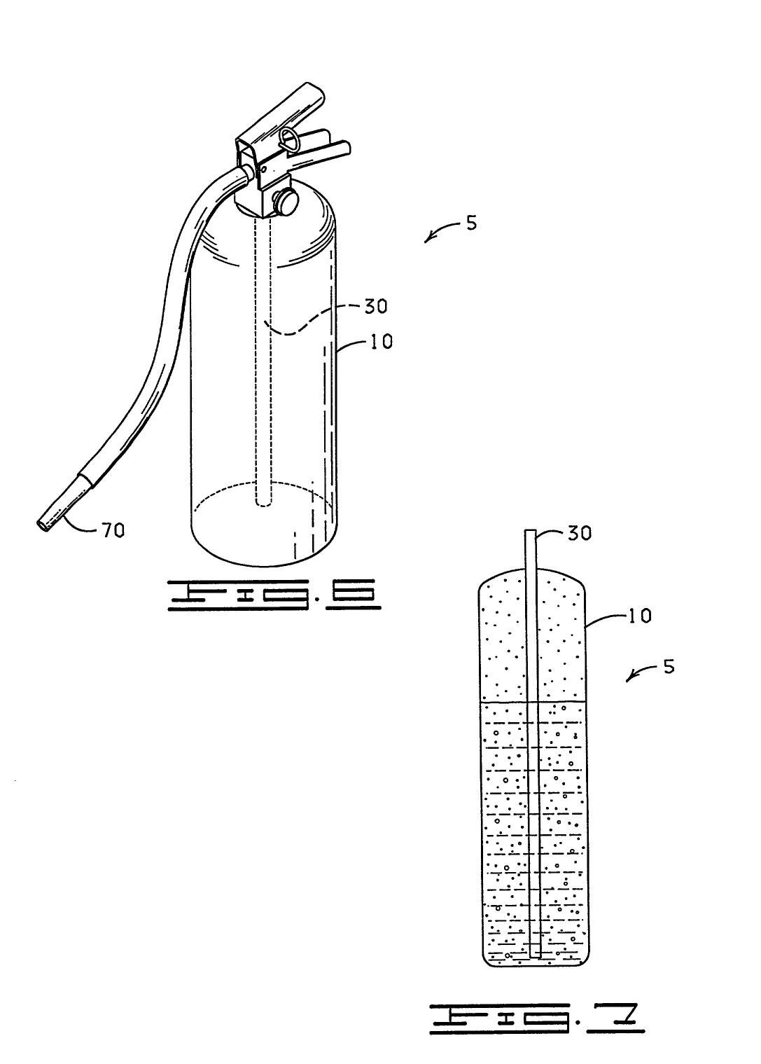

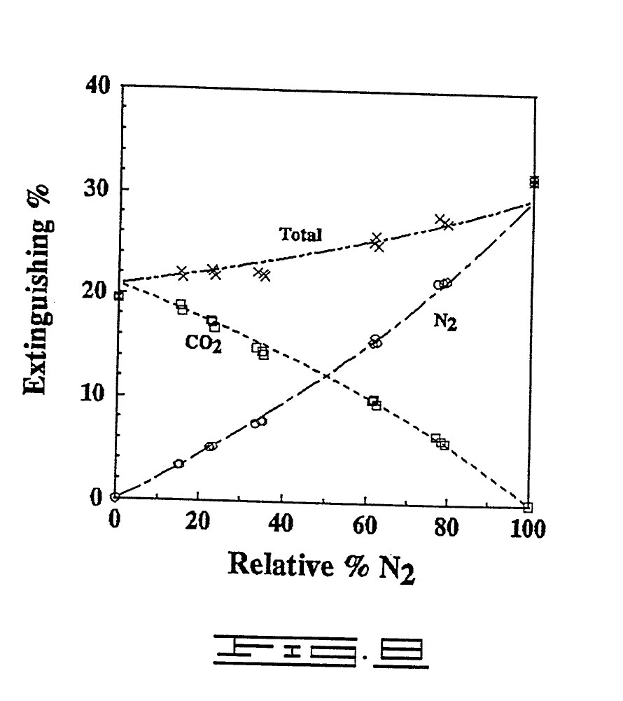

The present invention further contemplates a fire extinguisher, such as fire extinguisher 5 as shown in FIG. 6, containing non-halogenated chemical agents which are dissolved in liquid or supercritical CO₂. The non-halogenated chemical agents selected will be substantially soluble in CO₂ and thereby contribute significantly to flame extinguishment. However, they need not be volatile. Homogeneous solutions of non-halogenated chemical agents and CO₂ in a cylindrical container 10 as shown in FIG. 7, will reach a nozzle 70 and be discharged as a CO₂ snow, wherein the agent is operably associated with small dry ice particles, or as a liquid mist. The fire extinguishment composition in fire extinguisher 5 may be stored at ambient temperatures and under a vapor pressure approximating that of pure CO₂ (e.g., 60 atm at 20° C. to 70 atm at 30° C.). The amount of the chemical agent dissolved in the CO₂ will be determined by adding known amounts of the chemical agent to the CO₂. The use of a nitrogen physical agent to drive liquid fire-suppressant compositions through a siphon tube 30 results in a decrease in partial pressure within the cylinder during delivery, thereby leading to a significant decrease in agent flux as the agent is expelled. The contemplated CO₂ delivery method through fire extinguisher 5 overcomes this problem since the partial pressure inside cylinder 10 remains substantially constant (at the vapor pressure of the homogeneous solution) as the fire extinguishment composition exits through the siphon tube 30 toward the nozzle 70. The cooling effect which occurs within cylinder 10 is minimal due to the fact that the CO₂ and dissolved chemical agent are able to reach nozzle 70 in a homogeneous liquid form. At this point, the evaporative and expansion cooling effects, traditionally experienced, occur.

In studies using the fire extinguisher 5 with a fire extinguishment composition, cylinder 10 is first weighed empty, and then it is weighed after filling with the fire extinguishment composition and again after an amount of the fluid has been vented from cylinder 10 via siphon tube 30. Through the use of material balance relations, it is possible to determine whether or not a particular chemical agent is soluble in the liquid CO₂ at any given temperature and pressure. When a fire extinguishment composition is discharged from cylinder 10 through nozzle 70, the fire extinguishment composition may be dispersed as either a dry ice “snow” or as a clear liquid mist. For example, a 1.8 mol % solution of perfluorooctyl bromide and CO₂ discharges as “snow”, whereas 3.6 mol % of perfluoromethylcyclohexane in CO₂ discharges as a clear liquid. It is contemplated that a clear liquid CO₂ discharge will reduce visibility problems significantly.

### EXAMPLE II

In order to test this embodiment of the present invention, cup-burner tests were conducted using a method described in the literature and known to those of ordinary skill in the art. Pure heptane was used as the fuel, and various fire extinguishment compositions containing CO₂ or N₂ as the physical agent and CF₃Br or CF₂BrCl as the chemical agents were tested. Additional studies were also made of fire extinguishing compositions containing CO₂ as the physical agent and perfluoromethylcyclohexane or perfluoroethyl iodide as the chemical agent. The minimum vapor phase concentration of either the pure or mixed agents required to extinguish the flame is determined by gradually increasing the agent concentration until the flame abruptly vanishes.

Vapor pressures were measured for liquid solutions of several relatively nonvolatile chemical agents in CO₂. For example, at 10° C., the vapor pressure of a 0.07 mole fraction solution of perfluoromethylcyclohexane, a chemical agent, in liquid CO₂ is 600 psig, compared to a vapor pressure for pure CO₂ of 650 psig. At 20° C., the vapor pressure of a 0.07 mole fraction solution of perfluoromethylcyclohexane in CO₂ is 750 psig, and the vapor pressure of pure CO₂ is 833 psig. Even with the reduction in vapor pressure, solutions containing chemical agents, such as perfluoromethylcyclohexane in CO₂, will still retain a driving force comparable to pure CO₂ in forcing the fire extinguishment composition through the siphon tube.

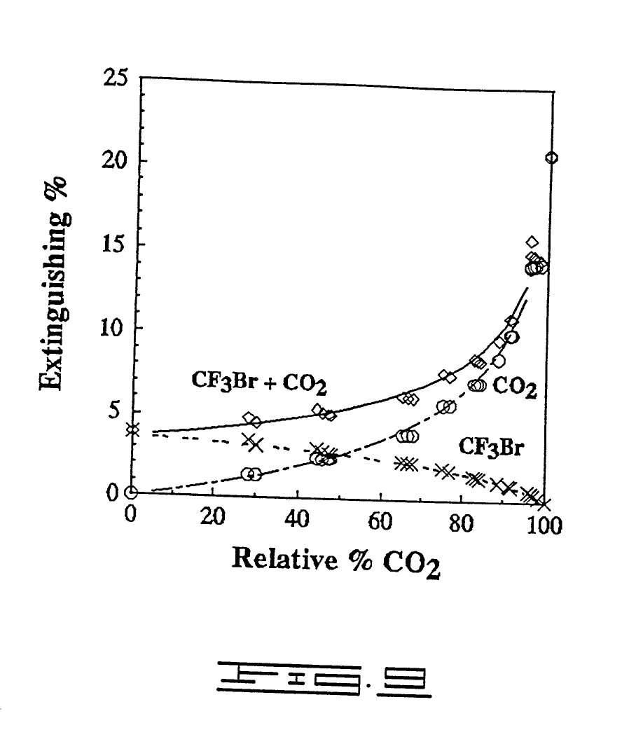

FIG. 8 (the results of which are tabulated in Table 2) plots the results of a cup burner test for a fire extinguishment composition comprising mixtures of CO₂ and N₂ added to the atmosphere surrounding a heptane flame.

TABLE 2
NITROGEN + CO₂ FIG. 8

| N₂% | CO₂% | N₂ + CO₂ | N₂(% rel) |
|---|---|---|---|
| 0.00 | 19.41 | 19.41 | 0.00 |
| 0.00 | 19.41 | 19.41 | 0.00 |
| 0.00 | 19.41 | 19.41 | 0.00 |
| 3.30 | 18.24 | 21.54 | 15.32 |
| 3.28 | 18.78 | 22.06 | 14.87 |
| 3.30 | 18.24 | 21.54 | 15.32 |
| 5.01 | 17.21 | 22.22 | 22.55 |
| 5.00 | 17.39 | 22.39 | 22.33 |
| 5.04 | 16.67 | 21.71 | 23.22 |
| 7.41 | 14.81 | 22.22 | 33.35 |
| 7.67 | 14.13 | 21.80 | 35.18 |
| 7.64 | 14.41 | 22.05 | 34.65 |
| 15.55 | 9.45 | 25.00 | 62.20 |
| 15.48 | 9.83 | 25.31 | 61.16 |
| 15.98 | 9.96 | 25.94 | 61.60 |
| 21.41 | 6.46 | 27.87 | 76.82 |
| 21.59 | 5.70 | 27.29 | 79.11 |
| 21.52 | 6.01 | 27.53 | 78.17 |
| 31.48 | 0.00 | 31.48 | 100.00 |
| 31.87 | 0.00 | 31.87 | 100.00 |
| 31.87 | 0.00 | 31.87 | 100.00 |

Ordinate values are the volume or mole percentages of the individual gases in the air (required for extinguishment) and the total of these percentages; the abscissa denotes the relative percentage of the physical agents present in the fire extinguishment composition. Thus, 32% of nitrogen or 21% of CO₂ acting alone will extinguish the flame; when the relative percentage of CO₂ is 50%, the mole percentage of each gas in the air stream is 12% and the total mole percentage required for extinguishment is 24%. The experimental results indicate that the curves are linear and that there does not appear to be any evidence to support a finding of cooperativity or anti-cooperativity in the fire extinguishment data for the two physical agents. The points in the figure represent experimental results, whereas the curves are predictions.

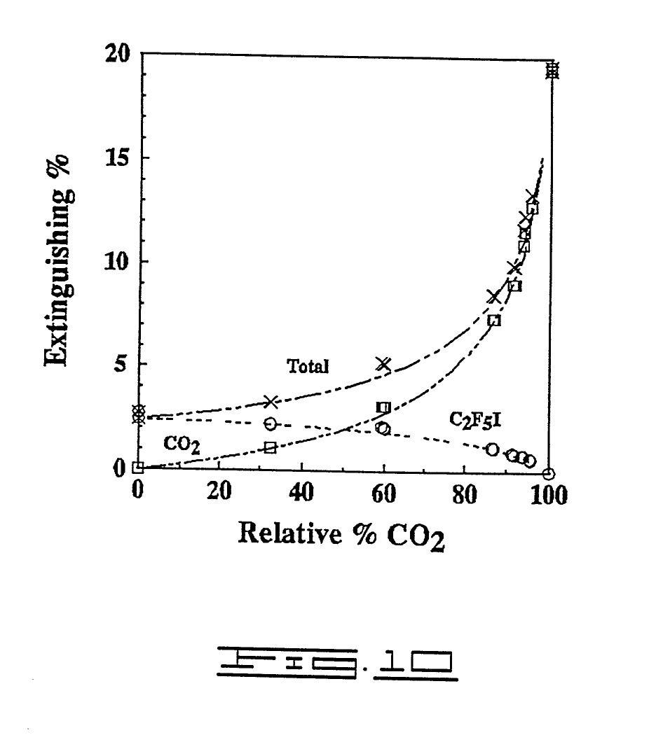

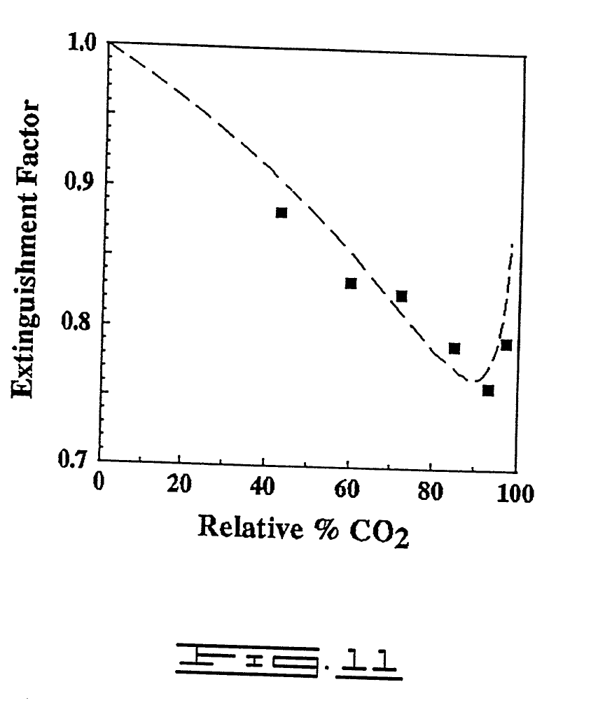

FIG. 9 and FIG. 10 (the results of which are tabulated in Table 3) plot the results of a cup burner test for fire extinguishment compositions comprising CF₃Br and C₂F₅I with CO₂, respectively.

TABLE 3
CO₂ + C₂F₅1 (perfluoroethyliodide) FIG. 10

| CO₂ | Agent | CO₂ + Agent | CO₂ (% rel) |
|---|---|---|---|
| 19.41 | 0.00 | 19.41 | 100.00 |
| 19.59 | 0.00 | 19.59 | 100.00 |
| 12.84 | 0.59 | 13.43 | 95.57 |
| 12.84 | 0.59 | 13.43 | 95.57 |
| 12.83 | 0.63 | 13.46 | 95.35 |
| 11.01 | 0.75 | 11.76 | 93.62 |
| 11.65 | 0.76 | 12.41 | 93.91 |
| 11.65 | 0.77 | 12.42 | 93.84 |
| 11.65 | 0.77 | 12.42 | 93.84 |
| 11.01 | 0.77 | 11.78 | 93.45 |
| 11.01 | 0.77 | 11.78 | 93.45 |
| 9.12 | 0.82 | 9.94 | 91.74 |
| 9.12 | 0.86 | 9.98 | 91.35 |
| 9.11 | 0.89 | 10.00 | 91.15 |
| 7.44 | 1.13 | 8.57 | 86.81 |
| 7.44 | 1.16 | 8.60 | 86.54 |
| 7.44 | 1.17 | 8.61 | 86.37 |
| 3.09 | 2.04 | 5.13 | 60.16 |
| 3.09 | 2.08 | 5.16 | 59.80 |
| 3.09 | 2.13 | 5.21 | 59.21 |
| 1.05 | 2.19 | 3.24 | 32.43 |
| 1.05 | 2.19 | 3.24 | 32.43 |
| 1.05 | 2.21 | 3.26 | 32.19 |
| 0.00 | 2.41 | 2.41 | 0.00 |
| 0.00 | 2.69 | 2.69 | 0.00 |

Evidence of cooperativity or synergistic effects occurring are shown by the plots of FIGS. 9 and 10 for each of the compositions. For example, when the physical agent percentage of CO₂ is reduced to half the mole percentage required for extinguishment by CO₂, acting alone (i.e., to ˜10.5%), the required percentage of the chemical agent in each case is reduced to approximately 25-30% of the value required for the chemical agent when acting alone to extinguish the flame. Similar cooperative or synergistic effects have also been observed in cup-burner tests conducted on fire extinguishment compositions containing mixtures of chemical agents with nitrogen.

The magnitude of the synergistic effect is apparent when the extinguishment factor F is calculated by the equation

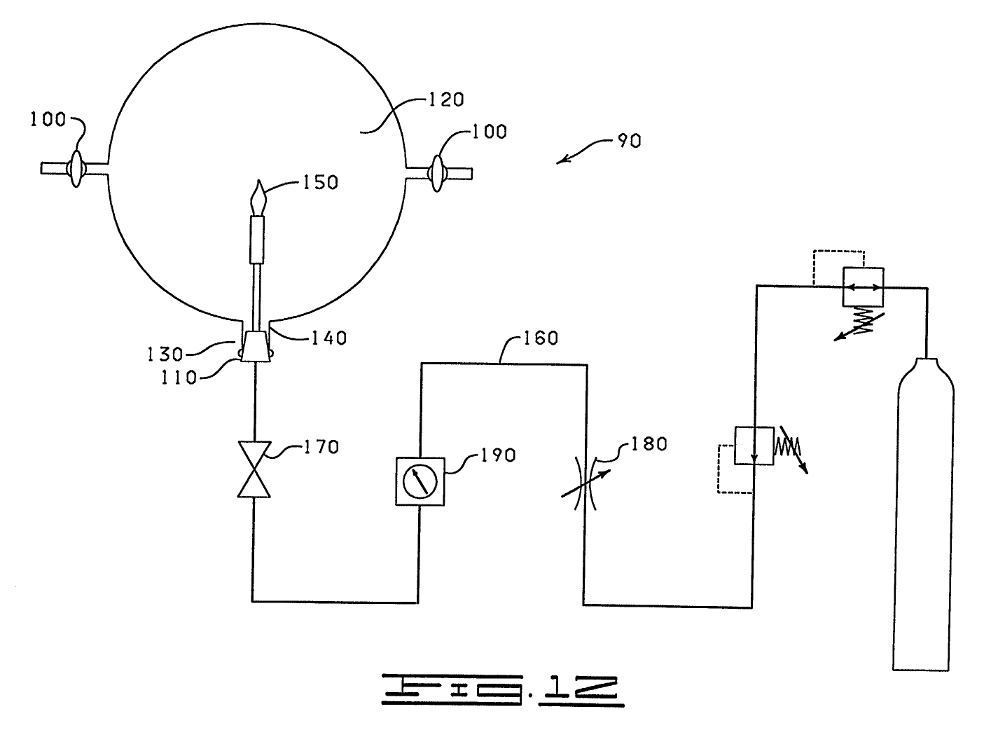

F=(A/Aₒ)+(B/Bₒ)

where Bₒ is the minimum percentage of chemical agent which is required to extinguish the fire in the absence of a physical agent, such as CO₂, and B is the percentage of chemical agent which is required to extinguish the flame when combined with a physical agent, such as CO₂. Similarly, Aₒ is the percentage of physical agent required to extinguish the flame in the absence of a chemical agent and A is the percent of physical agent required for flame extinguishment when combined with a chemical agent. Note that the extinguishment factor would be equal to one if there were no cooperative or synergistic effects provided by the mixture. Values of the extinguishment factor F are plotted in FIG. 11 for a fire extinguishment composition comprising Halon 1211 and CO₂ as a function of the relative percentage variable. A sharp minimum occurs in the plot of the actual experimental data as well as in the predicted curve, at approximately 90-95% relative concentration of CO₂. The curve suggests, therefore, that a 90:10 molar mixture of CO₂ and chemical agent may be quite effective in extinguishing flames; if the cup burner test results are extrapolated to larger-scale fire-fighting situations, extinguishment should be obtained when the atmosphere contains approximately 12% CO₂ and 1.3% of a chemical agent, such as C₂F₅I or CF₃Br.

The disadvantage of using CO₂ by itself for flame extinguishment in total flooding situations has been the health hazard CO₂ presents at the mole percentages required to extinguish the flame. The reduction of the amount of CO₂ required by a factor of 2 in mixtures containing an added chemical agent greatly decreases the risk to fire fighting personnel. Moreover, if only one-third to one-fourth as much chemical agent is required, health and environmental risks will be also reduced. There is also an obvious economic advantage in reducing the required concentrations of expensive chemical agents. Although the results given here are for CF₃Br and C₂F₅I, the invention contemplates that any physical agent and any chemical agent capable of providing synergistic fire extinguishment effects in combination, may be used.

### EXAMPLE III

A simple laboratory apparatus is described for observing the performance of fire-extinguishing agents for use in total flooding applications. Known compositions of agents mixed with dry air were prepared in a 2L glass combustion flask, and a flame (fed by propane butane, or other gaseous fuel from a pressure cylinder) is inserted into the flask through a standard taper joint. Burning times to extinguishment are measured, both in the absence and in the presence of added physical or chemical agent(s). From the known rate of burning of propane and initial compositions, the volume percentages of the gases in the combustion flask at extinguishment are calculated for each burning time. Agents that are not sufficiently volatile to be investigated with the ordinary cup burner method are readily studied with this technique.

Fires in enclosed spaces are sometimes extinguished by total flooding, in which a sufficient quantity of a gaseous or volatile agent is delivered throughout the air space to extinguish the fire. Determinations of the total amount of agent required are made with a variety of tests in which enclosures or actual rooms are filled with agent at known compositions. The large scale nature of these tests make them expensive and they introduce numerous variables into the system which are related to possible loss of agent, inhomogeneity of the air/agent mixture, and variation in temperature and/or humidity, to name but a few. Therefore, a smaller scale pan test procedure has been designed which will obtain burning times to extinguishment for fire-suppressant agents added to an 8-liter enclosure. In particular, this procedure was designed to test the extinguishment capability of perfluoroalkylamines, although it is contemplated for use with any chemical substance capable of extinguishing a flame. Described herein is a procedure and apparatus that can be used to introduce air and fire extinguishment mixtures of known composition into a small flask having a port at the bottom for insertion of a standardized hydrocarbon flame. A protocol for determining the ability of various agents to suppress flames is also described herein.

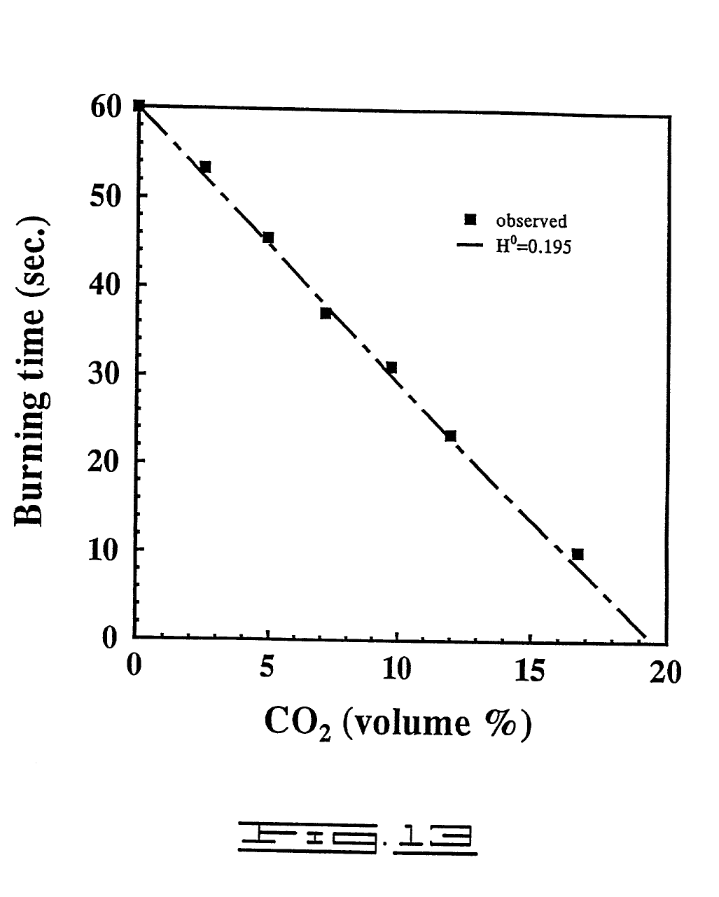

FIG. 12 is a schematic of a total flooding (non-flow) apparatus 90 as provided by the present invention, showing, in particular, the arrangement of Teflon-bore stopcocks 100 and a taper joint 110 at the bottom 130 of the flask 120, which serves as an entry port 140 for introduction of a flame 150. The main vessel 120 may be a 2L round-bottom borosilicate glass flask, mounted on a ring-stand (not shown). The flow of hydrocarbon gas (such as propane, butane, or other alkane) through the gas line 160 is regulated by a reducing valve 170 and a needle valve 180. A ball-type flowmeter 190 is used to indicate the total volume of propane (or other gas) introduced into flask 120. The height of the flame 150 is adjusted by varying the flow rate; however, in all of the experiments described here, a constant flow rate of 22 mL per minute was employed. All experiments were also performed at ambient temperatures of 22 to 23° C.

It is contemplated that several methods be used to introduce known initial quantities of physical and chemical agents. Carbon dioxide may be introduced by a volumetric gas syringe (not shown) which has been filled from a gas bottle containing carbon dioxide at atmospheric pressure. Volatile liquids, such as perfluoromethylcyclohexane may be introduced by a microsyringe (not shown) combined with a weighing technique in order to determine accurately how much of the compound has been added. Even liquids like perfluorooctane or perfluorooctylbromide, which have vapor pressures of only a few torr at room temperature, may be added with a microsyringe provided that the total amounts added do not exceed the saturation concentration of vapors. Furthermore, vapors of sufficiently volatile liquids may be introduced by using a gas-tight syringe (not shown). Alternatively, gaseous agents of sufficient density may be introduced with a syringe and the amounts delivered determined by weight difference. Because CO₂ is an important physical agent and also a combustion product, an infrared analyzer was used, such as Anarad model AR50, in order to determine the percentages of the compound in the atmosphere, to check the accuracy of the gas syringe addition method, and to determine final volume (or mole) percentages of CO₂ after combustion has taken place.

Flame extinguishment tests were performed by inserting the flame 150 through the taper joint 110 at the bottom 130 of the combustion flask 120. The flame 150 fits tightly within the taper joint 110, and the two stopcocks 100 are kept open to allow the system to “breathe” during combustion. A stopwatch is used to measure the total burning time, starting at the moment the flame is introduced into the flask.

In the total flooding experiments described hereinbelow and in the cup burner measurements described above, the results consist of sets of concentrations of the gases present in air and added agents that are just sufficient to suppress a flame. The cup burner data was obtained by allowing air containing known concentrations of added agents to flow through a chimney and past the flame. As the concentration of an added agent or agent mixture was gradually increased, with all other variables held constant, the flame suddenly extinguishes at a highly-reproducible known percentage of agent. Thus, if measured amounts of CO₂ (a physical agent) and Halon 1301 (CF₃Br) (a chemical agent) are added to the atmosphere, the experimental results consist of known percentages of these agents in the feed stream at extinguishment.

In tests conducted with the new total flooding apparatus, known concentrations of CO₂ and chemical agents are added initially to combustion flask 120. Subsequently, the oxidation of propane produced CO₂ and H₂O as long as the flame persists. At the extinguishment point, the time of burning is noted. If the stoichiometry corresponds to complete combustion of propane, one can calculate the composition of the extinguishing mixture from the burning time and the known flow rate of propane into the flask. All of the total flooding experiments were performed with a constant flow rate of 22 mL per minute, so that the total amounts of CO₂ and H₂O produced and O₂ consumed by the combustion could be calculated in each case. As a check on the quantity of CO₂ produced, measured values of CO₂ volume percents were obtained at self-extinguishment; these quantities represented the amount of CO₂ added initially (if any) plus the amount generated by combustion. The total amount of CO₂ produced was quite consistent with the stoichiometry required by the reaction: C₃H₈+50₂=3CO₂+4H₂O.

When only physical flame extinguishment agents are present, adiabatic flame temperatures can be readily calculated for the combustion of hydrocarbon fuels. The heat of combustion of the fuel and the composition of the air need to be known; heat capacities of the gases in the air and of the combustion products are required as functions of temperature. Previously, it has been shown that in the combustion of propane and other hydrocarbons, the flame temperature corresponding to the extinguishment percentage is nearly the same for a variety of types of physical agents. Thus, if 20% CO₂, 32% N₂, or 4% of perfluorohexane are sufficient (individually) to suppress a propane flame, nearly the same minimum flame temperature (approximately 186° K) is achieved at the extinguishment point in each case. If any of the compounds decompose chemically at temperatures approaching the flame temperature, allowance may be made for the enthalpy of decomposition, but for the usual physical agents and the gases in the air this effect seems to be relatively unimportant.

In analyzing the present data, it was necessary to first calculate a maximum temperature (Tₘₐₓ) corresponding to the adiabatic combustion of propane in dry air without added agents. The minimum temperature at extinguishment (Tₘᵢₙ) for CO₂ as the only added agent (present at 19.5 volume percent) was also calculated. Tₘᵢₙ does not change when physical agents alone and their mixtures (including N₂, CO₂, and the HFC's or perfluorinated alkanes) are added to the air to produce extinguishment.

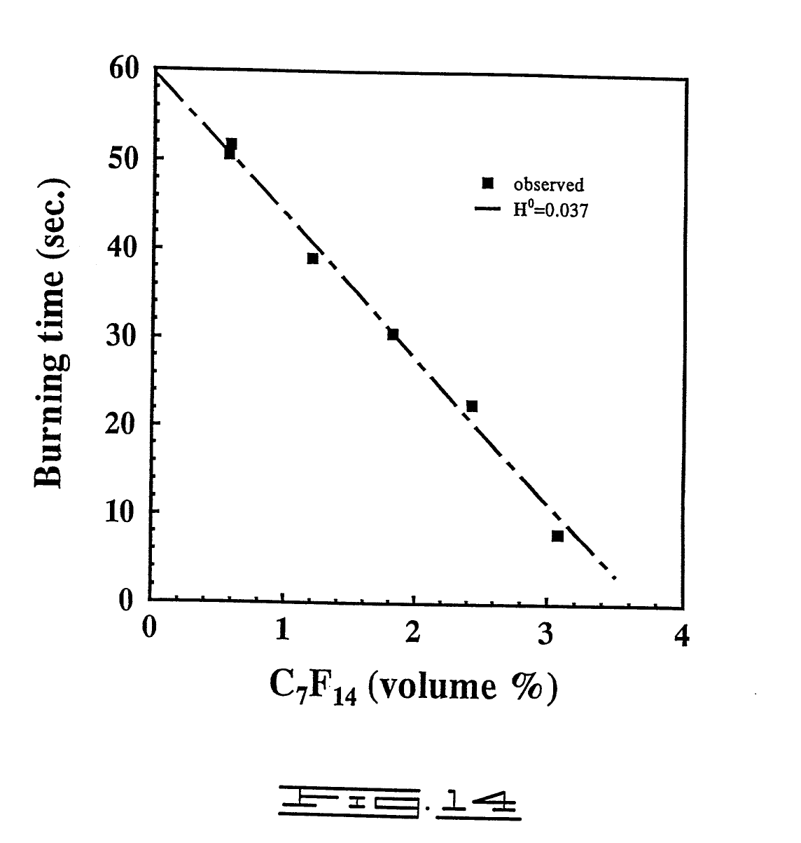

FIG. 13 represents the results of the total flooding experiments performed with varying percentages of CO₂ added initially to the air in the combustion flask. The burning times are plotted against volume percentages of CO₂ in the combustion flask before the flame is introduced. The extrapolated value of the CO₂ percent, corresponding to a burning time of zero, is determined to be 19.5±0.5%. The line in the figure is predicted using only the Tₘᵢₙ value (obtained by adiabatic flame temperature calculations), the known compositions of all gases in the flask after flame extinguishment, and the known heat capacities of all the gases. Both the linearity of the plot and the good agreement between theory and experiment support the proposition that the same minimum flame temperature is reached at each extinguishment point.

FIG. 14 shows analogous combustion data for perfluoromethylcyclohexane (PFMC), plotted as burning time against volume percentages of PFMC initially in the flask. The line in FIG. 14 is computed using the adiabatic flame temperatures and utilizing the calculated compositions of all the gases in air (accounting for the depletion of O₂ and production of CO₂ and H₂O). The molar heat capacity of PFMC was not available, but it appears to be directly proportional to the molar heat capacity of a reference compound, such as FM200, at each temperature. The proportionality constant is chosen to give the same calculated minimum flame temperature (Tₘᵢₙ) for the agent at 3.7% (its approximate extinguishment percentage) as is calculated for CO₂. The apparent linearity of the plot of burning time versus volume percentages of PFMC, support the proposition.

A chemical agent (or better stated, an agent that can contribute free radicals which interact with radical chain reactions in the flame) can, because of thermal effects, lower the flame temperature to Tₒ, a temperature intermediate between the limiting temperatures (Tₘₐₓ and Tₘᵢₙ). In modelling the extinguishment results for mixtures containing a chemical agent, Tₒ is first calculated from estimated heat capacity data and the known percentage of the chemical agent required (alone) for extinguishment (Aₒ). This value, Aₒ, is approximately equal to 0.022 (2.2%) for 1-iodoperfluorohexane and 0.017 (1.7%) for 1-bromoperfluorooctane.

In an alternate embodiment of the invention, a fire extinguishment composition is provided as including an effective amount A of a first flame extinguishing agent and an effective amount B of a second substantially halogen free flame extinguishing agent. The fire composition in this embodiment is characterized by the formula (A/Aₒ)+(B/Bₒ)<1.00, where Aₒ is defined as an amount of the first flame extinguishing agent which is effective in extinguishing the flame when used alone, and Bₒ is defined as an amount of the second substantially halogen free flame extinguishing agent which is effective in extinguishing the flame when used alone.

For example, chemical agents now being studied as models for a new generation of halon replacements include several volatile metal-containing compounds, such as iron and nickel carbonyls and metal perfluoroacetonyl-acetonate complexes. Compounds of these types will dissolve in liquid carbon dioxide to produce homogeneous solutions suitable for fire-extinguishment applications. It has been determined that ferrocene (an iron complexed with cyclopentadiene) is sufficiently solvent in CO₂ so that its homogeneous solution in this solvent might be used in fire extinguishment. Further, many of the solution properties of fluid carbon dioxide are similar to those of the typical nonpolar liquid solvents. Thus, a wide variety of organic compounds (solids, liquids, and gases) are readily soluble either in liquid CO₂ or in the supercritical CO₂. For example, the common liquid alkanes, numerous aromatic compounds, and many fluorinated organic compounds dissolve readily in CO₂, as do chemical flame-extinguishment agents such as Halon 1301 (CF₃Br) and Halon 1211 (CF₂BrCl). Also, partially fluorinated surfactants are readily soluble in fluid CO₂. Inverse micelle formation occurs in solutions of some surfactants in organic solvents. Inverse micelles are quite effective in dissolving substantial concentrations of water and water-soluble salts. Therefore, water-soluble agents incorporated in the inverse micelles in liquid CO₂ are useful in fire extinguishment.

The concept of delivering chemical fire-extinguishment agents dissolved in liquid CO₂ has many potential advantages. First, there is no volatility requirement for the delivered agent, which will exist in a homogeneous solution under its own vapor pressure, stored in a CO₂ cylinder. The concentration of the agent in CO₂ must of course be large enough for effective flame extinguishment, but this will ordinarily not require a solubility greater than 5 to 10 mole percent in the homogeneous liquid phase. In suppressing fires, this CO₂-rich fluid will be dispensed through a siphon tube that is immersed well below the original liquid/vapor interface in the cylinder. As the homogeneous liquid solution is rapidly discharged, it will escape through the nozzle as a CO₂ “snow” (finely divided dry ice particles) or a liquid mist, depending on the amount and nature of the dissolved agent. Ejection of the homogeneous fluid from the cylinder will continue until the level of the liquid has dropped below the lower end of the siphon tube. During discharge, the driving pressure will be the vapor pressure of the liquid solution, practically equal to that of pure liquid CO₂ at the ambient temperature. In fire extinguishment use, the mixture would act by a combination of physical and chemical effects, thereby exploiting any cooperativity that may occur when both types of agents are present.

According to the experimental results, described hereinabove, a strong cooperative effect occurs between physical and chemical agents when only about 5 to 10 mole percent of the chemical agent is present in the CO₂/agent mixture delivered to the flame. It is believed that this type of synergism to the marked nonlinearity in the temperature dependence of the steady-state concentration of radicals in the propagating flame. Hence, delivery of moderate amounts of a physical agent to the flame greatly decreases the concentration of a chemical agent needed for flame extinguishment.

In yet another alternate embodiment of the present invention, a fire extinguishment composition is provided as including an effective amount A of a first flame extinguishing agent and an effective amount B of a second flame extinguishing agent. The fire extinguishment composition in this embodiment is characterized by the formula (Aₒ−A)/B>8, and more particularly greater than 10, where Aₒ is defined as an amount of the first flame extinguishing agent effective in extinguishing the flame when used alone. The first flame extinguishing agent is a chemical substance which is capable of extinguishing a flame by decreasing the amount of oxygen concentration in an atmosphere required to support combustion, by decreasing the flame temperature, or by combinations thereof. The second flame extinguishing agent is a chemical substance capable of releasing an effective amount of chemical fragments so as to interfere with a chemical chain mechanism responsible for propagation of a flame.

The present invention also provides a fire extinguishment composition prepared by a process which includes the steps of: (1) providing an effective amount A of a first fire extinguishing agent; (2) providing an effective amount B of a second fire extinguishing agent; and (3) combining the effective amount A of the first fire extinguishing agent with the effective amount B of the second fire extinguishing agent into a mixture. The fire extinguishing mixture, as prepared, is characterized by the formula (A/Aₒ)+(B/Bₒ)<0.80, and more particularly less than 0.75, where Aₒ is defined as an amount of the first fire extinguishing agent which is effective in extinguishing a fire when used alone, and Bₒ is defined as an amount of the second fire extinguishing agent which is effective in extinguishing a fire when used alone.

The present invention further provides a method for extinguishing a fire. The method comprises the steps of (1) providing an effective amount of a fire extinguishment composition; and (2) applying the effective amount of the fire extinguishment composition to a fire for extinguishing the fire. The fire extinguishment composition includes an effective amount A of a first flame extinguishing agent, and an effective amount B of a second flame extinguishing agent. The first and second flame extinguishing agents are combined to form a mixture, wherein the mixture is characterized by the formula (A/Aₒ)+(B/Bₒ)<0.80, and more particularly less than 0.75, where Aₒ is defined as an amount of the first fire extinguishing agent which is effective in extinguishing a fire when used alone, and Bₒ is defined as an amount of the second fire extinguishing agent which is also effective in extinguishing a fire when used alone.

In an alternate embodiment of the method of the present invention, the method includes the steps of (1) providing a fire extinguishment composition and (2) applying an effective amount of the fire extinguishment composition to a fire for extinguishing the fire. The fire extinguishment composition comprises a mixture of an effective amount A of a first flame extinguishing agent and an effective amount B of a substantially halogen-free flame extinguishing agent. The mixture is characterized by the formula(A/Aₒ)+(B/Bₒ)<1.00, where Aₒ is defined as an amount of the first flame extinguishing agent which is effective in extinguishing the flame when used alone, and Bₒ is defined as an amount of the second substantially halogen-free flame extinguishing agent which is effective in extinguishing the flame when used alone.

In another embodiment of the method of the present invention, a method for extinguishing a fire is provided which includes the steps of (1) providing a fire extinguishment composition and (2) applying an effective amount of the fire extinguishment composition to a fire for extinguishing the fire. It is contemplated that the fire extinguishment composition comprise an effective amount A of a first flame extinguishing agent and an effective amount B of a second flame extinguishing agent. The composition is characterized by the formula (Aₒ−A)/B>8, and more particularly greater than 10, where Aₒ is defined as an amount of the first flame extinguishing agent which is effective in extinguishing the flame when used alone.

The first flame extinguishing agent of this embodiment may be a chemical substance capable of extinguishing a flame by decreasing the amount of oxygen concentration in an atmosphere required to support combustion, by decreasing the flame temperature, or by combinations thereof. Furthermore, the second flame extinguishing agent may be a chemical substance capable of releasing an effective amount of chemical fragments so as to interfere with a chemical chain mechanism responsible for propagation of the flame.

The present invention also provides an apparatus for use in extinguishing a fire. The apparatus includes a housing having an interior surface, an exterior surface, and means for venting a fire extinguishment composition, and a fire extinguishment composition substantially deposited in the housing. The fire extinguishment composition comprises (1) an effective amount A of a first flame extinguishing agent, and (2) an effective amount B of a second flame extinguishing agent. The first and second flame extinguishing agents are combined to form a mixture characterized by the formula(A/Aₒ)+(B/Bₒ)<0.80, and more particularly less than 0.75, where Aₒ is defined as an amount of the first flame extinguishing agent which is effective in extinguishing the flame when used alone, and Bₒ is defined as an amount of the second flame extinguishing agent which is effective in extinguishing the flame when used alone.

The present invention further provides a fire extinguishment kit. The fire extinguishment kit includes an effective amount A of a first fire extinguishing agent and an effective amount B of a second fire extinguishing means. The fire extinguishment kit also includes a means for combining the first and second flame extinguishing agents in order to thereby provide a fire extinguishment mixture for application to a fire. The fire extinguishment mixture is characterized by the formula (A/Aₒ)+(B/Bₒ)<0.80, and more particularly less than 0.75, where Aₒ is defined as an amount of the first flame extinguishing agent which is effective in extinguishing a fire when used alone, and Bₒ is defined as an amount of the second flame extinguishing agent which is effective in extinguishing a fire when used alone.

Thus, it should be apparent that there has been provided in accordance with the present invention a fire extinguishment composition and a method for making and using same that fully satisfy the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A fire extinguishment composition, comprising:
an amount A of a first flame extinguishing agent; and
an amount B of a second flame extinguishing agent, wherein the composition is effective in extinguishing a flame when applied to the flame in an effective amount, and wherein the composition is characterized by the formula
(A/Aₒ)+(B/Bₒ)<0.80
wherein Aₒ is defined as an amount of the first flame extinguishing agent effective in extinguishing the flame when used alone, and Bₒ is defined as an amount of the second flame extinguishing agent effective in extinguishing the flame when used alone.

2. The fire extinguishment composition of claim 1, wherein the first flame extinguishing agent is a chemical substance capable of extinguishing a flame by decreasing the amount of oxygen concentration in an atmosphere required to support combustion decreasing the flame temperature, or combinations thereof, and the second flame extinguishing agent is a chemical substance capable of releasing an effective amount of chemical fragments so as to interfere with a chemical chain mechanism responsible for propagation of the flame.

3. The fire extinguishment composition of claim 2, wherein the second flame extinguishing agent is a halogen-containing fluorohydrocarbon compound.

4. The fire extinguishment composition of claim 3, wherein the halogen-containing fluorocarbon compound is selected from the group consisting of iodinated, brominated, and chlorinated fluoroalkanes and combinations thereof.

5. The fire extinguishment composition of claim 4, wherein the halogen-containing fluorocarbon compound is diiodomethane.

6. The fire extinguishment composition of claim 2, wherein the second flame extinguishing agent is selected from the group consisting of iodinated, brominated, and chlorinated alkanes and combinations thereof.

7. The fire extinguishment composition of claim 6, wherein the second flame extinguishing agent is selected from the group consisting of pentafluoroethyliodide, perfluorohexyliodide, and perfluorooctylbromide.

8. The fire extinguishment composition of claim 2, wherein the second flame extinguishing agent is Halon 1301 or Halon 1211.

9. The fire extinguishment composition of claim 2, wherein the second flame extinguishing agent is selected from the group consisting of metal carbonyl, metal compounds containing carbonyl and CF₃ groups, and combinations thereof.

10. The fire extinguishment composition of claim 9, wherein the second flame extinguishing agent is iron pentacarbonyl or chromium hexacarbonyl.

11. The fire extinguishment composition of claim 2, wherein the second flame extinguishing agent is a compound containing iodine which is capable of releasing iodine chemicals so as to interfere with the chemical chain mechanism responsible for propagation of the flame.

12. The fire extinguishment composition of claim 11, wherein the second flame extinguishing agent is selected from the group consisting of HI, I₂, and IBr.

13. The fire extinguishment composition of claim 2, wherein the second flame extinguishing agent is an inorganic substance containing bromine which is capable of releasing bromine chemicals so as to interfere with the chemical chain mechanism responsible for propagation of the flame.

14. The fire extinguishment composition of claim 13, wherein the second flame extinguishing agent is HBr.

15. The fire extinguishment composition of claim 2, wherein the first flame extinguishing agent is selected from the group consisting of nitrogen, helium, argon and mixtures thereof.

16. The fire extinguishment composition of claim 2, wherein the first flame extinguishing agent is carbon dioxide.

17. The fire extinguishment composition of claim 2, wherein the first flame extinguishing agent is a fluorohydrocarbon.

18. The fire extinguishment composition of claim 17, wherein the fluorohydrocarbon first flame extinguishing agent is FM-200.

19. The fire extinguishment composition of claim 2, wherein the first flame extinguishing agent is carbon dioxide and the second flame extinguishing agent is CH₂I₂.

20. The fire extinguishment composition of claim 2, wherein the first flame extinguishing agent is FM-200 and the second flame extinguishing agent is CH₂I₂.

21. The composition of claim 1, further characterized by the formula
(A/Aₒ)+(B/Bₒ)<0.75.

22. A fire extinguishment composition, comprising:
an amount A of a first agent, the first agent being effective in extinguishing a flame by reducing the concentration of oxygen available to the flame to a concentration below that required to support combustion, decreasing the flame temperature, and combinations thereof; and
an amount B of a second agent, the second agent being effective in extinguishing the flame by releasing chemical fragments for interfering with a chemical chain mechanism responsible for propagation of the flame,
wherein the composition is effective in extinguishing a flame when applied to the flame in an effective amount, and
wherein the composition is characterized by the formula
(A/Aₒ)+(B/Bₒ)<0.80
wherein Aₒ is defined as an amount of the first flame extinguishing agent effective in extinguishing the flame when used alone, and Bₒ is defined as an amount of the second flame extinguishing agent effective in extinguishing the flame when used alone.

23. The composition of claim 22, further characterized by the formula
(A/Aₒ)+(B/Bₒ)<0.75.

24. A fire extinguishment composition prepared by a process comprising the steps of:
providing an amount A of a first fire extinguishing agent;
providing an amount B of a second fire extinguishing agent; and
combining the amount A of the first fire extinguishing agent with the amount B of the second fire extinguishing agent into a mixture,
wherein the composition is effective in extinguishing a flame when applied to the flame in an effective amount, and
wherein the mixture is characterized by the formula
(A/Aₒ)+(B/Bₒ)<0.80
wherein Aₒ is defined as an amount of the first extinguishing agent effective in extinguishing a fire when used alone, and Bₒ is defined as an amount of the second fire extinguishing agent effective in extinguishing a fire when used alone.

25. The composition of claim 24, further characterized by the formula
(A/Aₒ)+(B/Bₒ)<0.75.

26. A method for extinguishing a fire, comprising the steps of:
providing an effective amount of a fire extinguishment composition comprising:
an amount A of a first flame extinguishing agent, and
an amount B of a second flame extinguishing agent, and
wherein the composition is characterized by the formula
(A/Aₒ)+(B/Bₒ)<0.80
wherein Aₒ is defined as an amount of the first flame extinguishing agent effective in extinguishing the fire when used alone, and Bₒ is defined as an amount of the second flame extinguishing agent effective in extinguishing the fire when used alone; and
applying the effective amount of the fire extinguishment composition to the fire for extinguishing the fire.

27. The method of claim 26 wherein in the step of providing an effective amount of a fire extinguishment composition, the composition is further characterized by the formula (A/Aₒ)+(B/Bₒ)<0.75.

28. An apparatus for use in extinguishing a fire, comprising:
a housing having an interior surface, an exterior surface, and means for venting a fire extinguishment composition; and
a fire extinguishment composition substantially deposited in the housing, and selectively dischargeable therefrom such that upon activation of the venting means, the fire extinguishment composition is substantially venting from the fire extinguishing apparatus wherein the fire extinguishment composition comprises:
an amount A of a first flame extinguishing agent, and
an amount B of a second flame extinguishing agent, and
wherein the composition is characterized by the formula
(A/Aₒ)+(B/Bₒ)<0.80
wherein Aₒ is defined as an amount of the first flame extinguishing agent effective in extinguishing the fire when used alone, and Bₒ is defined as an amount of the second flame extinguishing agent effective in extinguishing the fire when used alone.

29. The apparatus of claim 28 wherein the fire extinguishment composition is further characterized by the formula (A/Aₒ)+(B/Bₒ)<0.75.

30. A fire extinguishing kit, comprising:
an amount A of a first fire extinguishing agent;
an amount B of a second fire extinguishing agent; and
means for combining the first and second flame extinguishing agent to provide a fire extinguishment mixture for application to a fire;
wherein, the fire extinguishment mixture is characterized by the formula
(A/Aₒ)+(B/Bₒ)<0.80
wherein Aₒ is defined as an amount of the first flame extinguishing agent effective in extinguishing a fire when used alone, and Bₒ is defined as an amount of the second flame extinguishing agent effective in extinguishing a fire when used alone.

31. The apparatus of claim 30 wherein the fire extinguishment mixture is further characterized by the formula (A/Aₒ)+(B/Bₒ)<0.75.

32. A fire extinguishment composition, comprising:
an amount A of a first flame extinguishing agent; and
an amount B of a second substantially halogen free flame extinguishing agent,
wherein, the composition is characterized by the formula
(A/Aₒ)+(B/Bₒ)<1.00
wherein Aₒ is defined as an amount of the first flame extinguishing agent effective in extinguishing the fire when used alone, and Bₒ is defined as an amount of the second substantially halogen free flame extinguishing agent effective in extinguishing the fire when used alone.

33. A method for extinguishing a fire, comprising the steps of:
providing a fire extinguishment composition comprising:
an amount A of a first flame extinguishing agent,
an amount B of a second substantially halogen free flame extinguishing agent,
wherein the composition is characterized by the formula
(A/Aₒ)+(B/Bₒ)<1.00
wherein Aₒ is defined as an amount of the first flame extinguishing agent effective in extinguishing the fire when used alone, and Bₒ is defined as an amount of the second substantially halogen free flame extinguishing agent effective in extinguishing the fire when used alone; and
applying an effective amount of the fire extinguishment composition to a fire for extinguishing the fire.

34. A fire extinguishment composition, comprising:
an amount A of a first flame extinguishing agent; and
an amount B of a second flame extinguishing agent,
wherein the composition is characterized by the formula
(Aₒ−A)/B>8
wherein Aₒ is defined as an amount of the first flame extinguishing agent effective in extinguishing the fire when used alone.

35. The fire extinguishment composition of claim 34, wherein the first flame extinguishing agent is a chemical substance capable of extinguishing a flame by decreasing the amount of oxygen concentration in an atmosphere required to support combustion, decreasing the flame temperature, or combinations thereof, and the second flame extinguishing agent is a chemical substance capable of releasing an effective amount of chemical fragments so as to interfere with a chemical chain mechanism responsible for propagation of the flame.

36. A method for extinguishing a fire, comprising the steps of:
providing a fire extinguishment composition, wherein the fire extinguishment composition comprises:
an amount A of a first flame extinguishing agent,
an amount B of a second flame extinguishing agent,
wherein the composition is characterized by the formula
(Aₒ−A)/B>8
wherein Aₒ is defined as an amount of the first flame extinguishing agent effective in extinguishing the fire when used alone; and
applying an effective amount of the fire extinguishment composition to a fire for extinguishing the fire.

37. The fire extinguishment composition of claim 36, wherein the first flame extinguishing agent is a chemical substance capable of extinguishing a flame by decreasing the amount of oxygen concentration in an atmosphere required to support combustion, decreasing the flame temperature, or combinations thereof, and the second flame extinguishing agent is a chemical substance capable of releasing an effective amount of chemical fragments so as to interfere with a chemical chain mechanism responsible for propagation of the flame.
